(19) United States
(12) Patent Application Publication
(10) Pub. No.: US 2002/0180158 A1
(43) Pub. Date: Dec. 5, 2002

(54) Sealing mechanism for rotating equipment

(76) Inventor: Denver Secord, Oliver (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 09/870,746

(22) Filed: Jun. 1, 2001

(51) Int. Cl. F16J 9/00

(52) U.S. Cl. 277/500

(57) ABSTRACT

A seal for a piston in a circulating piston device such as a motor has a number of rearwardly angled vanes. The piston circulates in an annular passage. The vanes bear against walls of the passage. In one embodiment the vanes are pivotally mounted to a piston and have centers of mass which are located so that centrifugal forces on the vanes, which result from the circulation of the piston, help to bias the vanes against walls of the passage. Each radially inward vane has a center of mass located forward from a pivot axis of the vane. Each radially outward vane has a pivot axis located rearward from a pivot axis of the vane.

### TECHNICAL FIELD

This invention relates to seals for rotating equipment. The invention has particular application in sealing rotary motors, engines, pumps or compressors of the type which have a piston which moves around an annular groove or “cylinder”. The invention relates to piston seals suitable for use in such an engine, motor, pump or compressor and to devices, such as engines, motors pumps or compressors equipped with such seals.

### BACKGROUND

The inventor's previous U.S. Pat. No. 5,520,147, (“Secord”) describes a rotary motor or engine which has at least one rotor which is mounted within a cylindrical bore in an engine block. The cylindrical bore in which the rotor turns is partially overlapped by a cylindrical bore in which a rotary gate valve is mounted. The rotor has one or more lobes or “pistons”. Each lobe moves around a circular path in an annular groove as the rotor turns. The rotary gate valve turns in synchronization with the rotor so that it blocks off the groove just after a lobe on the rotor has passed by. The space between the gate valve and the lobe forms an expandable “combustion chamber”. Gases in the combustion chamber exert forces on the lobe which drive the piston around its groove. The gases may be pressurized by internal combustion within the combustion chamber or may be pressurized externally and delivered to the “combustion chamber” under pressure.

Circulating piston engines have the advantage that all motion is rotary motion. There are no power losses caused by the need to convert reciprocating motion to rotary motion as is the case in a conventional piston engine.

One challenge posed by the motor described by Secord as well as other motors in which a piston circulates around an annular “cylinder” is to provide suitable seals around the piston so that gases do not escape past the sides of the piston. Poor seals can reduce the efficiency of these motors. On the other hand, the seals should not create too much drag between the piston and the walls of the channel in which the piston circulates. While there are various types of seals which may be used with a rotary motor of the general type described in U.S. Pat. No. 5,520,147, there remains a need for a better way to provide piston seals in such a circulating piston motor.

Another challenge posed by such motors is to provide a motor which is exceptionally compact and has a reduced number of moving parts.

### SUMMARY OF THE INVENTION

This invention provides a piston seal for a circulating piston motor of the type in which a piston is mounted to circulate in an annular passage. The piston comprises an arcuately elongated piston member. The piston seal comprises a plurality of vanes projecting outwardly and rearwardly form the piston member at locations spaced apart along the piston member, the vanes brush against walls of the passage as the piston circulates.

In some embodiments the passage is generally toroidal and the vanes are formed in the shape of the frustum of a cone. In these embodiments the cone preferably has a cone angle of about 45 degrees. Such embodiments may be constructed so that, in a rearward portion of the piston, the vanes are circularly symmetrical and extend completely around the piston.

In some preferred embodiments the vanes are stiff, pivotally mounted to the piston member, have rearward portions which can move toward or away from the piston member when the vanes pivot and, on a radially inward side of the piston, the vanes have centers of mass located forward from centers of pivoting of the vanes. When the piston is circulating in the passage, centrifugal forces acting on the vanes bring the rearward portions of the radially inward vanes against a radially inward wall of the passage. The faster the piston is circulating the larger are the forces which bias the rearward portions of the vanes against the radially inward wall of the passage. Preferably the vanes are mounted on arms extending from the piston member and the arms are curved rearwardly.

Another aspect of the invention provides a rotary motor comprising a piston mounted to circulate in an annular passage. The piston comprises an arcuately elongated piston member equipped with a seal comprising a plurality of vanes projecting outwardly and rearwardly form the piston member at locations spaced apart along the piston member. The vanes brush against walls of the passage. In preferred embodiments the vanes are stiff, pivotally mounted to the piston member, have rearward portions which can move toward or away from the piston member when the vanes pivot about and, on a radially inward side of the piston, the vanes have centers of mass located forward from centers of pivoting of the vanes. When the piston is circulating in the passage, centrifugal forces acting on the vanes bring the rearward portions of the radially inward vanes against a radially inward wall of the passage. Preferably the vanes are mounted to rearwardly curved arms extending from the piston member.

A further aspect of the invention provides a method for sealing a piston in a rotary motor having a piston which circulates about a center of rotation in an annular passage. The method comprises: providing a vane pivotally mounted to the piston, the vane pivotal about a pivot axis and having a center of mass located forward from the pivot axis; allowing a rearward end of the vane to bear against a wall of the passage radially inwardly from the piston; and, as the piston circulates in the passage, allowing centrifugal forces acting on the center of mass of the vane to bias the center of mass radially outwardly, thereby biassing the rearward end of the vane against the wall of the passage.

### BRIEF DESCRIPTION OF THE DRAWINGS

In drawings which illustrate non-limiting embodiments of the invention:

FIG. 1 is an exploded perspective view of one form of the rotary engine according to this invention;

FIG. 2 is a sectional view taken along line 2-2 of FIG. 1, with the components separated for clarity;

FIG. 3 is a sectional view taken along line 3-3 of FIG. 2, illustrating a possible timing gear arrangement;

FIG. 4 is a sectional view taken along line 4-4 of FIG. 2, illustrating four rotors having a common rotary gate valve;

FIG. 5 is a sectional view taken along line 5-5 of FIG. 2, illustrating the pistons within their respective annular recesses;

FIG. 6 is a sectional view taken along line 6-6 of FIG. 2, illustrating the location of the labyrinth seals for the central rotary gate valve;

FIG. 6A is an enlarged portion of FIG. 6;

FIG. 7 is an enlarged sectional view taken on line 7-7 of FIG. 4 illustrating a piston nested within its respective recess;

FIG. 8 is an enlarged sectional view taken along line 8-8 of FIG. 7;

FIG. 8A is a generalized perspective view of a piston similar to that of FIG. 8 and mounted on the periphery of a rotor;

FIGS. 9, 10 and 11 are sequential views illustrating the rotational movement of the central rotary gate valve and a piston as the piston rotates past an intake port of the engine;

FIG. 12 is a sectional view of the rotary engine of this invention wherein a metering valve housing containing apertured disks in synchronous rotation with the pistons and central seal permit fuel inflow and exhaust gas outflow;

FIG. 13 is a sectional view taken on line 13-13 of FIG. 12;

FIG. 14 is a perspective view of a modified form of the piston;

FIG. 15 is an enlarged vertical section through the modified piston when positioned within a recess;

FIG. 16 is a sectional view taken along line 16-16 of FIG. 15;

FIG. 17 is an enlarged portion of part of the piston shown in FIG. 16;

FIG. 18 is an enlarged portion of FIG. 18;

FIGS. 19A and 19B are schematic drawings illustrating the effect of the location of a center of mass of a vane used to seal a circulating piston;

FIG. 20 is an exploded perspective view of an alternative embodiment of the invention relating to a further modified form of the rotor piston;

FIG. 20A is a schematic perspective view of the rotor and the seal portion of the piston of FIG. 20;

FIG. 20B is a sectional view taken along line 20B-20B of FIG. 20A;

FIG. 21 is a sectional view of the embodiment of the invention shown in FIG. 20; and,

FIG. 22 is a sectional view taken along line 22-22 of FIG. 21.

### DESCRIPTION

The following description explains by way of example how this invention may be applied in circulating-piston rotary engines. The invention is not, however, limited to providing seals in such engines. The invention may also be used to provide seals in pumps or other types of rotating equipment. Some of the rotary engines described below are considered to be inventive themselves.

Circulating piston rotary engines have one or more rotating members or “rotors” which bear projecting pistons. The pistons circulate in annular cylinders. The rotating members are preferably discs. Several rotary members may be located at spaced apart locations along a drive shaft. A rotary engine may have multiple shafts which are connected to rotate together.

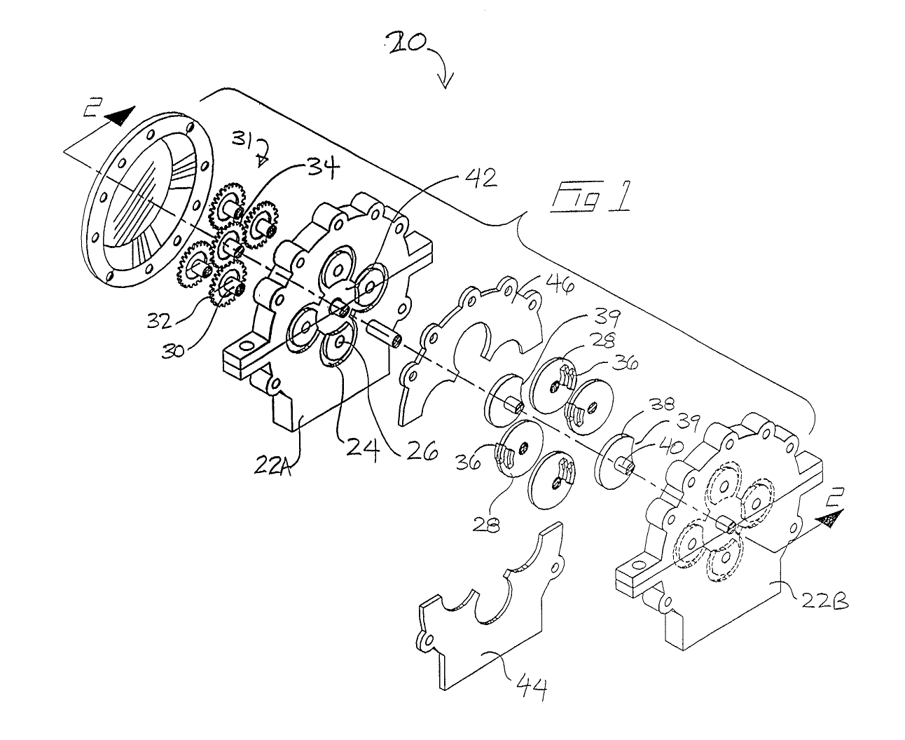

FIG. 1 shows an exploded perspective view of one form of rotary engine according to this invention. Engine 20 has an engine block 22 made of several sections (sections 22A and 22B are shown in FIG. 1). Each section of engine block 22 has a plurality of annular grooves 24 which intersect a central cylindrical depression 42. A bore 26 is concentric with each of the annular grooves 24.

Rotors 28 are rotatably mounted to shafts 30 which pass through bores 26. Each rotor 28 has a projecting lobe or “piston member” 36 which fits into and circulates within a corresponding one of grooves 24. Each groove 24 defines a channel within which its piston member circulates. Each piston member 36 is arcuately elongated with a center of curvature which coincides with the center of its rotor 28. Each piston member 36 is located at a radius from its center of curvature substantially equal to the radius of its annular groove 24. When rotors 28 are mounted with their piston members 36 in grooves 24 then, as rotors 28 rotate, piston members 36 sweep around grooves 24. The forward end of each piston member is the end that leads as the piston member circulates in its groove 24.

Where, as in FIG. 1, there are multiple rotors 28, the rotation of all of the rotors is coordinated by a suitable gear train 31. The organization of gear train 31 is best illustrated in FIG. 3. In the embodiment of FIGS. 1 and 3, gear train 31 includes a central gear 34 which is in mesh with a number of surrounding gears 32. All of gears 32 have the same number of teeth and therefore all rotate in the same direction at the same angular speed in a synchronous manner.

Rotary valves 38 are mounted on a shaft 40 which is connected to and driven by central gear 34. Each rotary valve 38 has a cut out portion 39. In FIG. 1, cut out portions 39 have the form of arcuate recesses. Rotary valves 38 rotate in cylindrical depressions 42 which intersect the paths of one or more grooves 24. Gear train 31 coordinates the rotation of shafts 30 and 40 so that a rotary valve 38 blocks the ends of each groove 24 where the groove 24 intersects with depression 42 except when a piston 36 is passing through region 42. This invention could also be applied to motors of the type which have reciprocating gate valves.

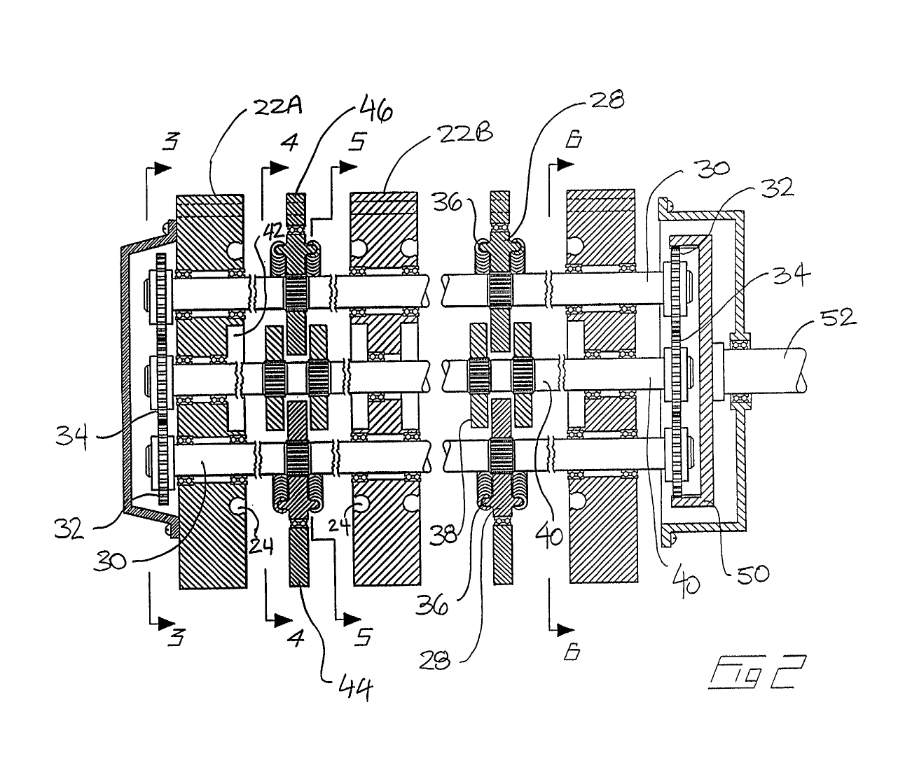

In the embodiment illustrated in FIG. 1 there are eight pistons 36 mounted on four rotors 28. As shown in FIG. 2, embodiments of motor 20 which have a larger number of pistons can be made by stacking a number of engine block sections each equipped with one or more rotors 28 in modular fashion. Spacers 44 and 46 maintain a proper separation between each pair of block members 22A and 22B. The embodiment of FIG. 2 has two sections stacked together which collectively provide sixteen pistons. An output drive shaft 52 is turned by a ring gear 50 which engages gears 32 on one end of the motor.

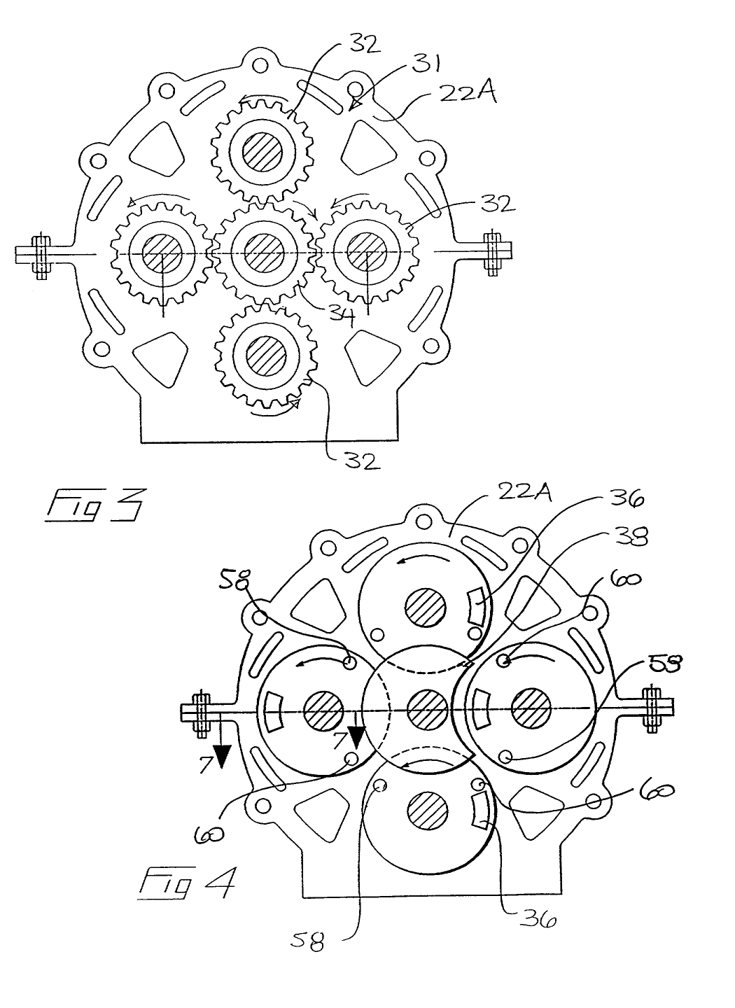

As shown in FIG. 4, each groove 24 has an inlet port 58 and an outlet port 60. The motor 20 illustrated in the drawings is a pneumatically driven motor. As such it lacks an input system for introducing a fuel/air mixture and it lacks any ignition system. The basic design and layout of motor 20 could also be used as a basis for an internal combustion engine by adding such systems in manners which will be clear to those skilled in the art.

In the illustrated embodiment, pressurized gas, such as pressurized air from a source of pressurized air (not shown) may be introduced into chambers 57 (see FIGS. 4 and 5) through a suitable valve system (not shown in FIGS. 1-8) and inlet ports 58. Inlet ports 58 are located in chambers 57 which are defined between each piston 36 and the portion of rotary valve 38 which closes groove 24 behind piston 36 shortly after piston 36 has entered groove 24 from area 42. The pressurized gas introduced into chambers 57 from inlet ports 58 forces pistons 36 around grooves 24. When each piston 36 has passed substantially entirely around groove 24 exhaust ports 60 are opened. This allows each piston 36 to enter area 42 and pressurized gas behind each piston 36 to escape. The operation of rotary piston engines of the same general type as engine 20 is described in more detail in U.S. Pat. Nos. 5,520,147 and 5,350,287 which are hereby incorporated by reference.

Those skilled in the art will understand that there is a need in a circulating piston engine, such as engine 20, to provide an effective seal to prevent the pressurized gas behind pistons 36 from blowing past pistons 36 in the clearance between pistons 36 and the walls of groove 24. Similar sealing problems are encountered in other types of rotary machinery.

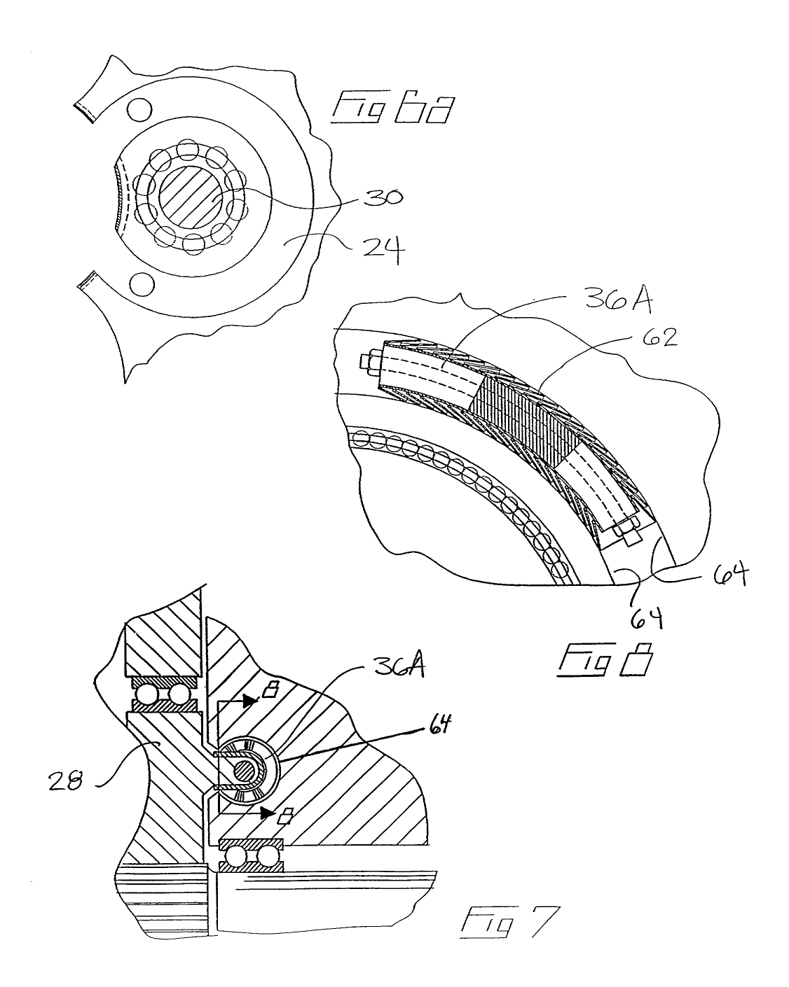

FIGS. 7 and 8 illustrate a piston assembly 36A according to one embodiment of the invention. Piston assembly 36A has a number of rearwardly inclined fins 62 (which may also be called ‘vanes’). Fins 62 are contoured to fit against the walls 64 of grooves 24. In the embodiment of FIGS. 7 and 8, each groove 24 has a generally toroidal configuration with curved walls and a rounded cross-section. Each of fins 62 generally has the form of the frustum of a cone. Because there are a significant number of fins 62, a good seal is maintained around piston 36A even if one or more of fins 62 does not seal perfectly against wall 64 of groove 24. Further, increased gas pressure behind piston 36A tends to force fins 62 into better sealing contact with walls 64 of groove 24. Fins 62 are fabricated from a suitable resilient material. Fins 62 preferably intersect walls 64 at an angle of about 45 degrees to the direction of motion of piston 36A. The particular characteristics of fins 62 depend on their location on piston 36A.

FIG. 8A illustrates a piston 36B which is mounted on the peripheral edge of a rotor 28A. Piston 36B has a forward section 66F, a mid-section 65 and a rear section 66R. Forward section 66F and rear section 66R have fins 62B which extend completely around piston 36B. Central portion 65 of piston 36B is attached to a projection 37 which extends from rotor 28. Fins 62A extend around portion 65. Forward section 66F and rearward section 66R are attached to central section 65 by a curved bolt 68. Piston 36B has a cross sectional shape which matches that of the groove within which it circulates. In the embodiment of FIG. 8A, piston 36B has a circular cross sectional shape. Other shapes may also be used.

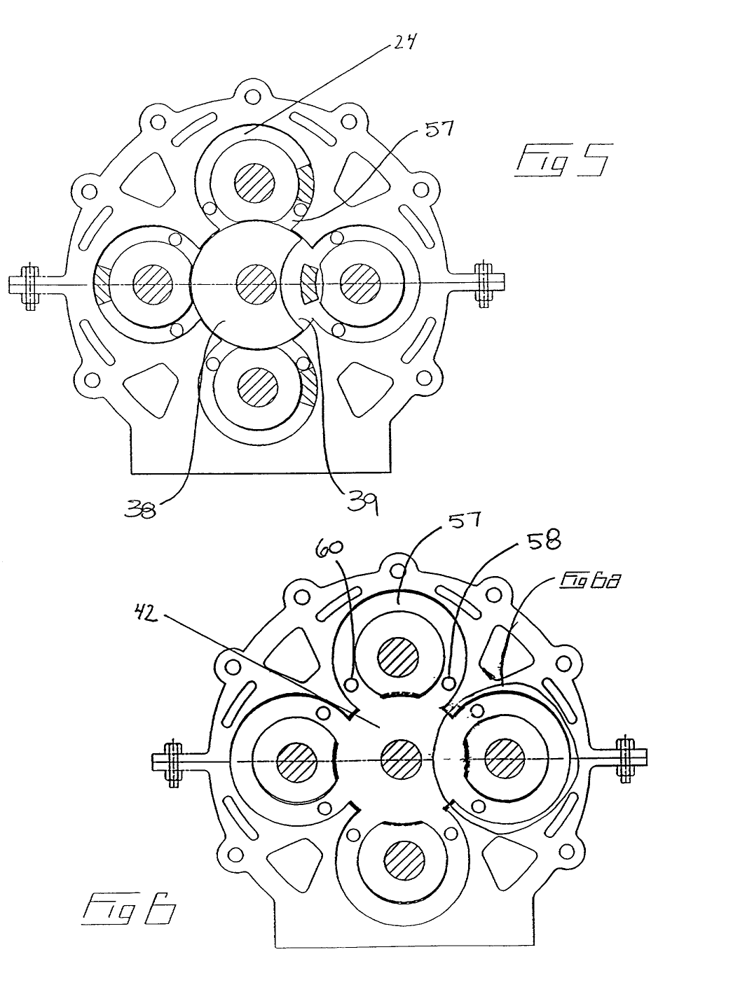

An advantage of the embodiment of FIGS. 6, 7 and 8 is that fins 62 are forced against the walls 64 of groove 24 by pressure within groove 24 behind piston 36A. The greater the pressure the more forcefully fins 62 are brought into contact with wall 64. Conversely, as the pressure behind piston 36A decreases, the fins are pressed less tightly against the walls 64 of groove 24. In this manner, when it is necessary for motor 20 to be run at low speeds to deliver high torque with higher pressures in grooves 24, fins 62 are pressed tightly against the walls of grooves 24 to provide good seals. In low speed operation it is less important to reduce friction between fins 62 and wall 64 of groove 24. When motor 20 is operating at higher speeds with lower air pressures, fins 62 are pressed less tightly against the walls of groove 24 and therefore the friction between piston 36A and groove 24 is lower.

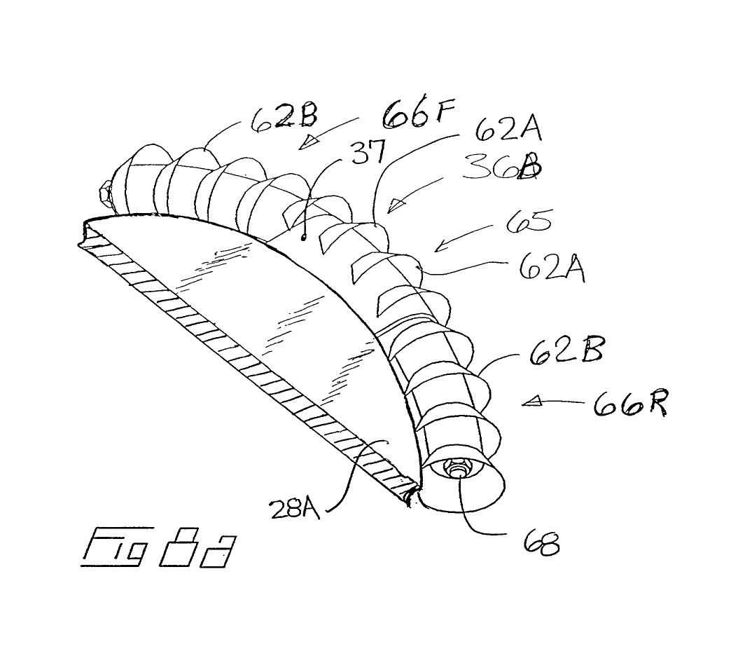

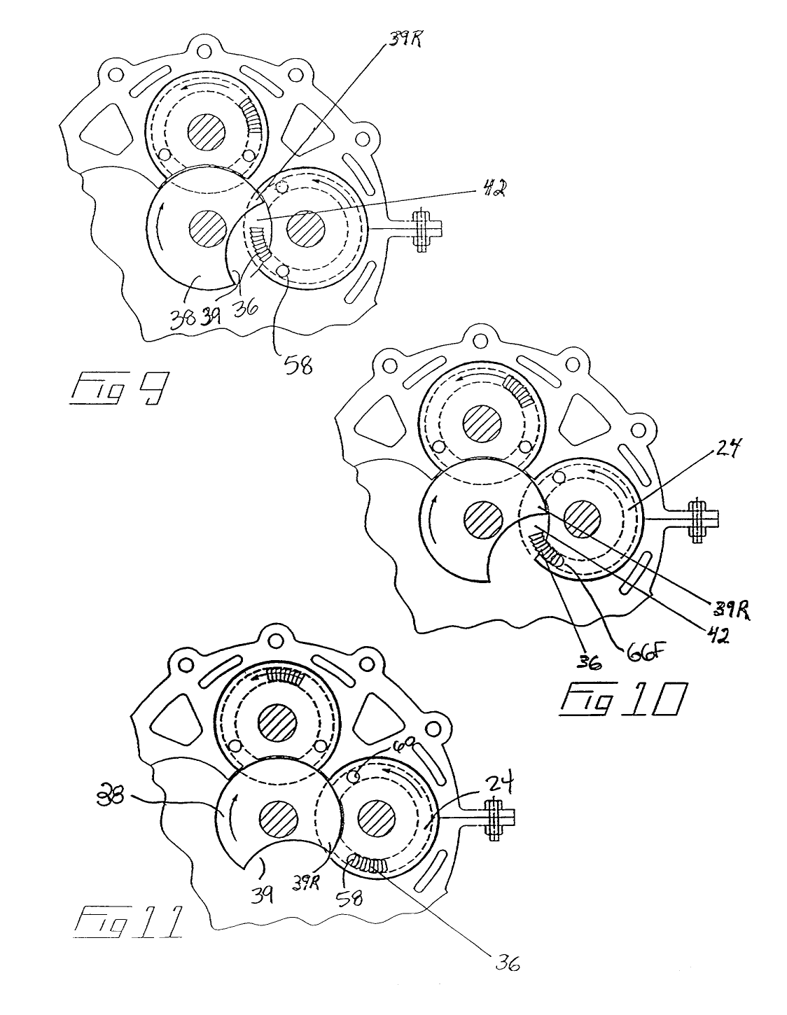

FIGS. 9, 10 and 11 are sequential views which illustrate the coordination between the rotary movement of rotary valve 38 and a piston 36 as piston 36 rotates from exhaust port 60 to intake port 58 of motor 20. In FIG. 9, piston 36 has just passed through area 42. The leading edge of piston 36 (more specifically, with respect to embodiment 36A, forward section 66F) is just entering groove 24. Section 39R of rotary valve 38 is just coming across to close the rear end of groove 24. In FIG. 10, section 39R has moved into a position where groove 24 is completely blocked behind piston 36. Piston 36 has advanced into groove 24 so that only a small portion of piston 36 is in volume 42. Finally, in FIG. 11, section 39R of rotary valve 38 has moved to a position such that rotary valve 38 blocks both ends of groove 24, piston 36 has fully entered groove 24 and piston 36 has moved far enough forward in groove 24 to expose inlet port 58.

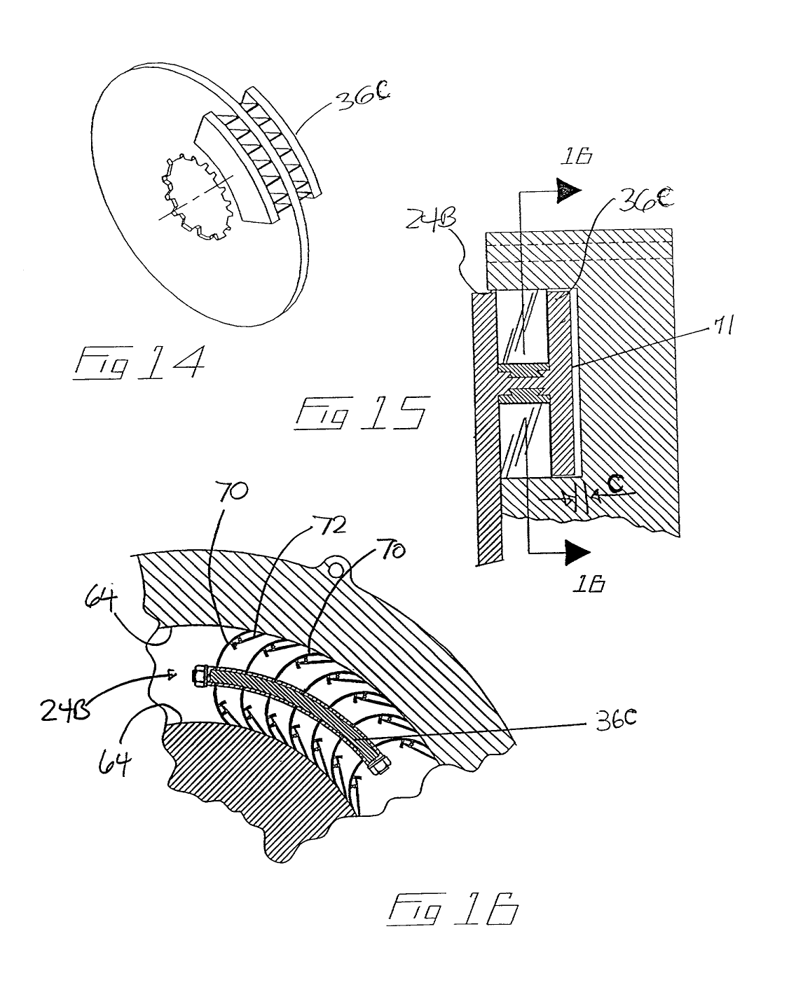

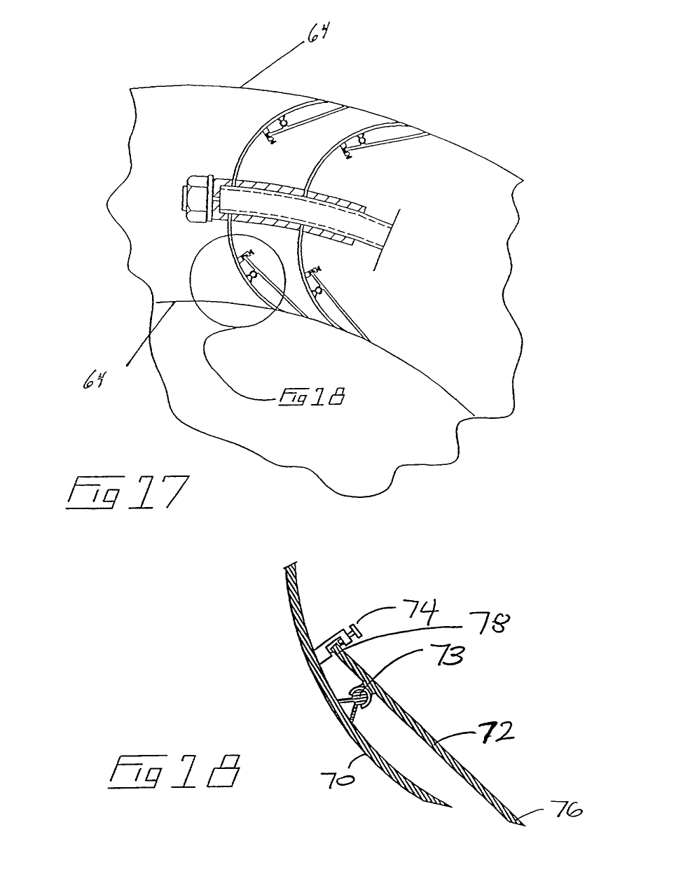

FIGS. 14 through 18 show a piston 36C according to an alternative embodiment of the invention. As shown in FIG. 15, a piston 36C according to this alternative embodiment of the invention fits into a parallel-sided annular groove 24. Piston 36C is sealed by seals which include vanes 72. Vanes 72 are biassed into contact with wall 64 of groove 24 by centrifugal force. A small clearance C is left between end 71 of piston 36C and the adjacent face of groove 24. A labyrinth seal (not shown) or a brush seal as shown in U.S. Pat. No. 5,749,584 may be provided between end 71 of piston 36C and the adjacent face of groove 24.

Piston 36C has a number of outwardly extending arms 70. Arms 70 almost, but not quite, touch walls 64 of groove 24. Arms 70 are preferably in the form of rearwardly swept deflectors which nearly, but not quite, touch the side walls of groove 24.

Each arm has mounted to it a vane 72. Each vane 72 is pivotally mounted to its respective arm. In this disclosure the term “pivotally” is not limited to mean only rotation about a precisely located, fixed pivot axis but includes flexible mountings the effect of which is to permit vanes 72 to tilt with respect to arms 70. The rearward tip 76 of the vane can be brought into contact with wall 64 by pivoting the vane slightly. It can be appreciated that vanes 72 can move with a teeter-totter like action about a pivot area 73 so that they can be biassed against wall 64 of groove 24. The rearward curve of arms 70 permits vanes 72 to pivot relative to arms 70 and to bear against walls 64 of groove 24 at a suitable angle, preferably roughly 30 to 45 degrees to the direction of motion of piston 36C around groove 24. As is the case of the embodiment described above, vanes 72 tend to be pressed against the walls of groove 24 by pressure differentials between the front and rear of piston 36C. With vanes 72 bearing against the walls of groove 24 the main path by which pressurized gas can leak past the sides of piston 36C (assuming suitable sealing between end 71 and the adjacent face of groove 24) is a zig-zag path which extends around the inner ends of vanes 72 and around the outer ends of arms 70. Since only small clearance is provided between arms 70 and the walls of groove 24 and since the clearance between arms 70 and vanes 72 can be made small, this zig-zag path provides substantial resistance to the passage of gas in the direction from the rear of piston 36C to the front of piston 36C.

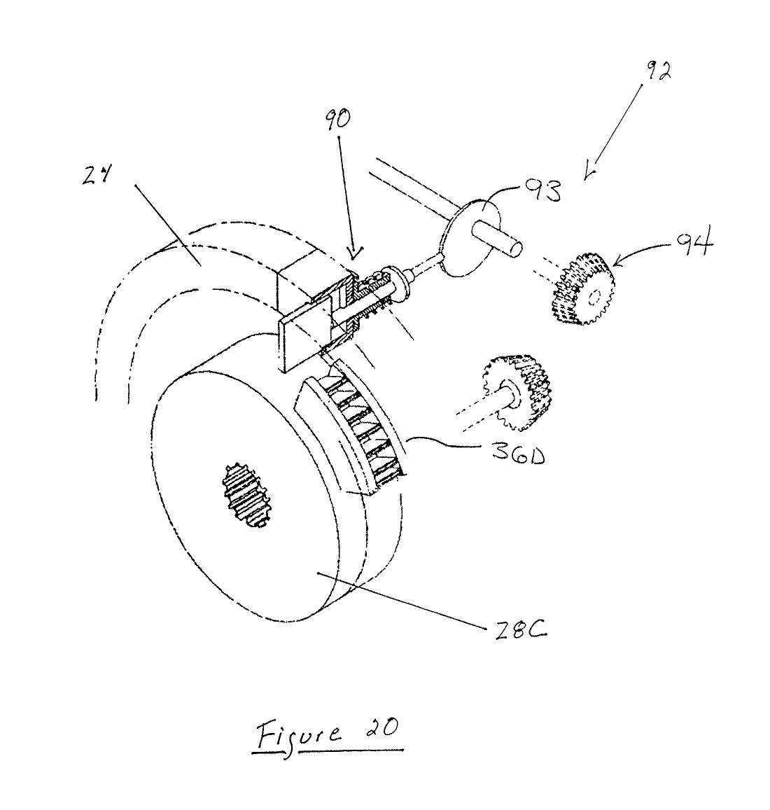

Pivot point 73 is so located with respect to the center of mass CG of vane 72 that centrifugal forces on vane 72 (which act on center of mass CG) cause trailing edge 76 to come into contact with wall 64B. For vanes 72 which are on the radially outward side of piston 36C, as shown in FIG. 19A, the center of mass CG of each vane 72 is located between pivot axis 73 and rearward end 76 of vane 72. Thus, when piston 36C is moving around groove 24, vane 72 runs with end 76 in sealing contact with wall 64 of groove 24. The force which presses end 76 against wall 64 increases with the rotational velocity of piston 36C around groove 24.

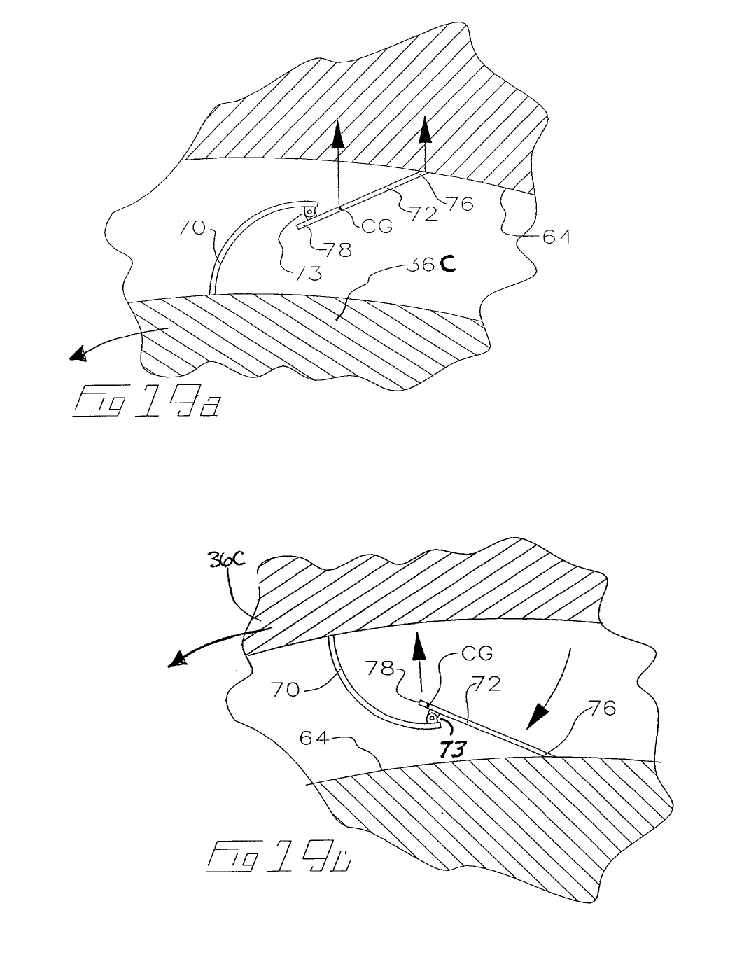

An adjustable stop 74 is preferably provided on member 70 (see FIG. 18). Stop 74 prevents end 76 from flying too far outwardly when piston 36C is passing through area 42. Stop 74 can be omitted in cases where the wall, against which vane 72 contacts, provides continuous support to vane 72 (as opposed to having gaps, such as area 42).

As shown in FIG. 19B, for vanes 72 on the radially inward side of piston 36, the center of mass CG of vane 72 lies forward from pivot axis 73 toward an inner end 78 of vane 72. Centrifugal forces acting through center of mass CG of vane 72 when piston 36C is rotating around groove 24 thereby cause center of mass CG of vane 72 to move radially outwardly (away from the radially inner wall of the groove 24). The outwardly directed centrifugal forces on the center of mass of vane 72 bring rearward ends 76 of the inside vanes 72 against the radially inner wall 64 of groove 24. Once again a stop 74 is preferably provided to prevent the outer end 76 of vane 72 from flying too far away from the center of piston 36C as piston 36C passes through area 42. It can be appreciated that piston 36C provides a better seal the faster piston 36C is circulating. Furthermore, the design of the seals on piston 36C counteracts the normal tendency in a rotary piston engine for the radially inward seal to fail to seal properly at high speeds because of the centrifugal force acting to push the piston and seal radially outwardly as the piston circulates. It is the relative location of center of mass CG and pivot 73 that is important. The location of the center of mass CG of vanes 72 relative to pivot 73 can be adjusted by affixing a weight to each vane 72, by making different parts of vanes 72 of materials having different densities, altering dimensions of vanes 72 and/or moving pivot 73 relative to vane 72.

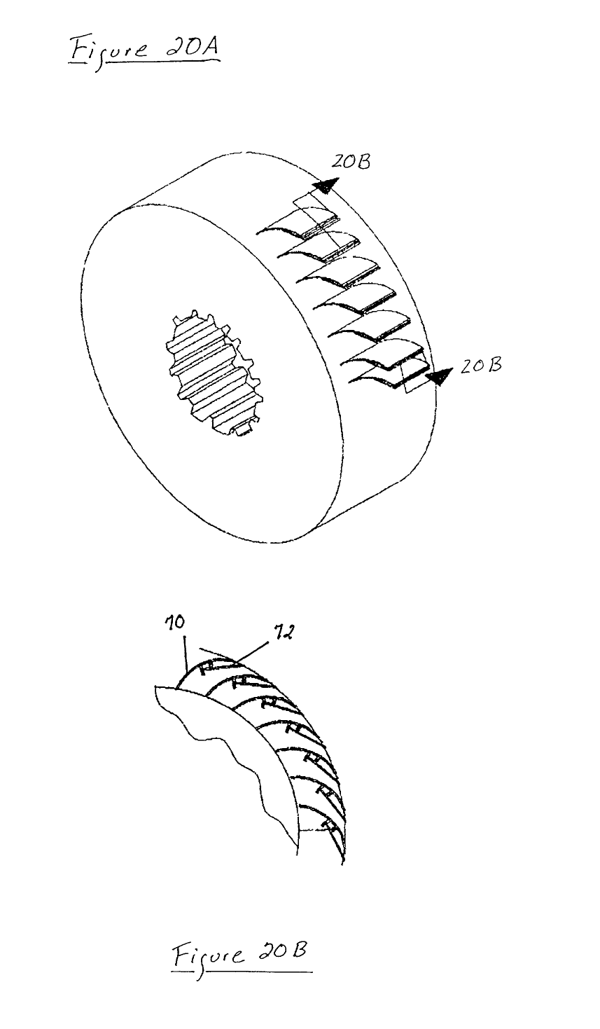

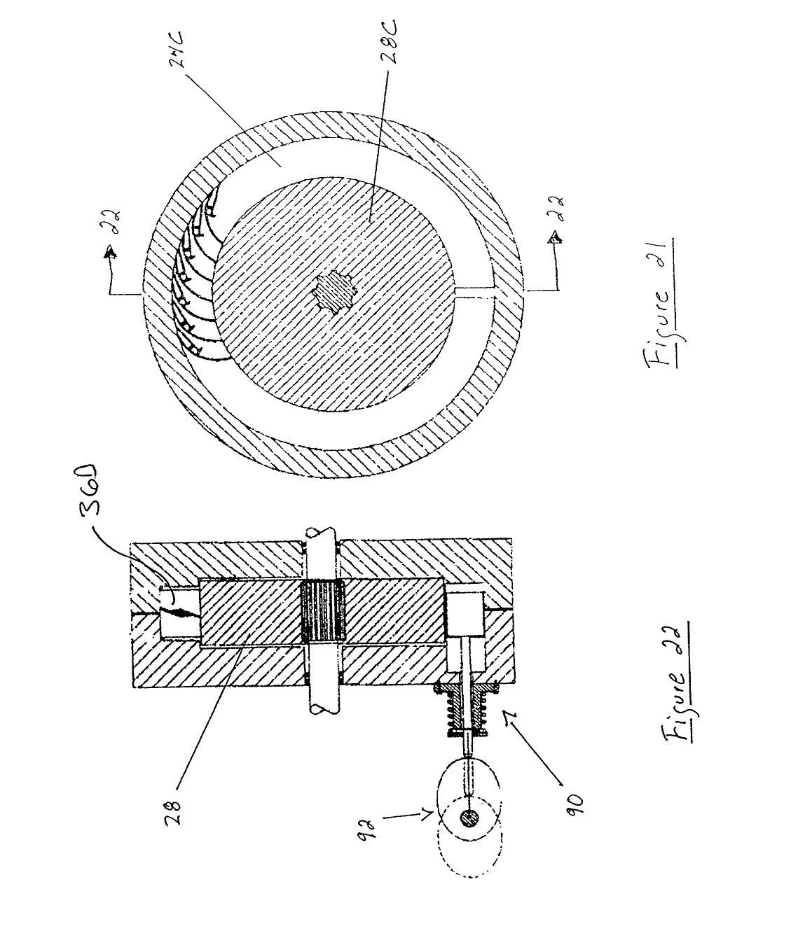

FIGS. 20-22 show an alternative embodiment of the invention in which an alternative piston 36D projects radially outward from a rotor 28C. Piston 36D is received in a parallel-sided annular groove 24 which is concentric with rotor 28C. Piston 36D incorporates a seal which comprises a number of vanes 72 mounted on arms 70 (see FIG. 22). Vanes 72 are biased so that their trailing edges bear against an adjacent surface of groove 24 as piston 36D circulates in groove 24. A guillotine valve 90 opens and closes at appropriate times to enable piston 36D to travel around groove 24. Valve 90 is operated by a timing mechanism 92 which includes a cam 93 which is driven synchronously with rotor 28C by a gear train 94.

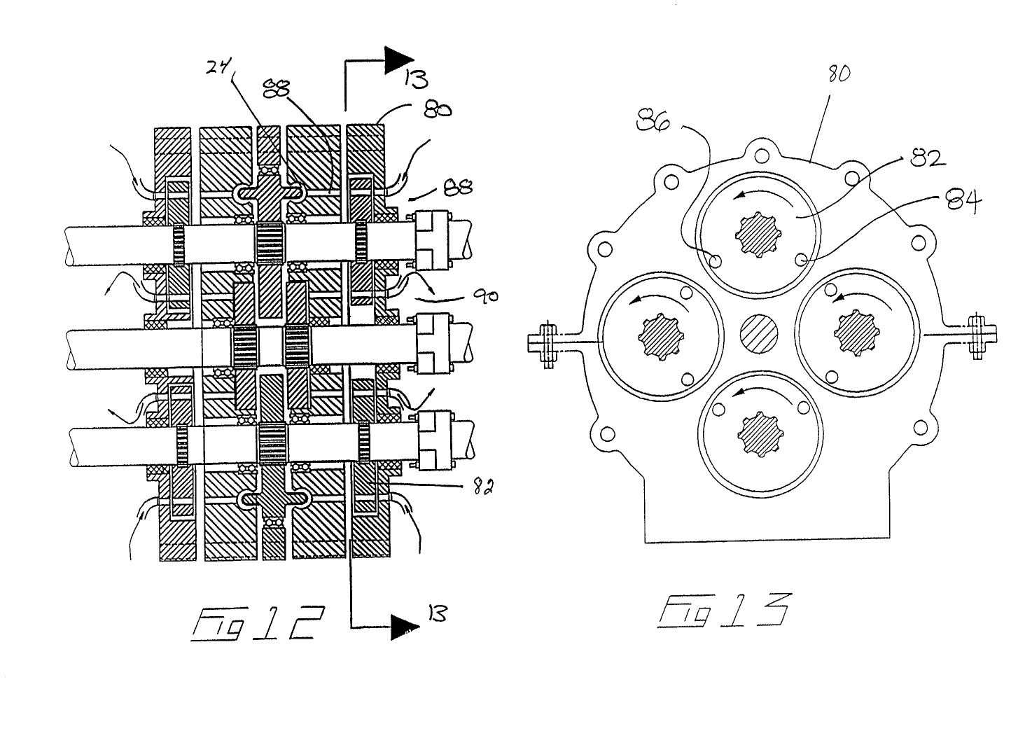

FIGS. 12 and 13 illustrate a valve system 80 which may be used to control the inflow and outflow of pressurized air into grooves 24. The valve system comprises one or more rotary valves. Each rotary valve comprises a disc 82 having holes 84, 86 penetrating it. As disc 82 rotates, disc 82 blocks the passage of fluid through an inlet passage 88 unless one of holes 84, 86 coincides with inlet passage 88. Fluid can pass through inlet passage 88 when the inlet passage is aligned with one of holes 84, 86. An outlet passage 90 is similarly blocked and unblocked. Because discs 82 are connected to rotate with shaft 30 which also drives rotors 28, the desired timing relationship between the position of rotors 28 and the times at which fluid is allowed to flow into or out of groove 24 is maintained.

The rotary engine of this invention uses a pressurized fluid, such as air, steam or hydraulic oil to drive its motions. It will be apparent to those skilled in the art, upon reading the foregoing disclosure, that a motor according to this invention could also be provided in the form of an internal combustion engine. Such an internal combustion engine would require some means for introducing a fuel/air mixture into grooves 24 behind a piston and then subsequently igniting the fuel/air mixture and providing an exhaust port in order to remove the combustion products. Such systems are well known to those skilled in the art and will therefore not be described here in detail.

Gear 50 (shown in FIG. 2) provides a speed reduction. In an internal combustion version of the engine, an air compressor may be provided to inject combustion air into grooves 24.

It can be appreciated that the foregoing description provides seals useful for sealing the pistons in motors and engines of the type which have a piston circulating in an annular groove. The embodiments of FIGS. 14-18 inventively use centrifugal forces to bias sealing elements against the walls of a groove on both inner and outer sides of a piston.

The foregoing description also provides highly compact and yet simply constructed arrangements for a circulating piston engine or motor.

As will be apparent to those skilled in the art in the light of the foregoing disclosure, many alterations and modifications are possible in the practice of this invention without departing from the spirit or scope thereof. For example:

seals according to this invention may be used in rotary piston engines having different constructions than those described above or in other mechanical devices in which a seal must be maintained between a rotating member and a wall.

seals according to this invention may be used to seal circulating piston pumps or gas compressors.

While the engines according to the invention preferably have multiple “pistons” a simple engine according to the invention could have a single piston circulating in a single annular groove.

The cross sectional shape of the annular groove and piston may be varied without departing from the invention.

Accordingly, the scope of the invention is to be construed in accordance with the substance defined by the following claims.

I claim:

1. A seal for a rotary device comprising a piston adapted to circulate in an annular passage, the piston comprising an arcuately elongated piston member, wherein the seal comprises a plurality of vanes projecting outwardly and rearwardly from the piston at locations spaced apart along the piston, the vanes brushing against walls of the passage.

2. The seal of claim 1 wherein the passage is generally toroidal and the vanes are each formed in the shape of the frustum of a cone.

3. The seal of claim 2 wherein the cone has a cone angle of about 45 degrees.

4. The seal of claim 2 wherein, in a rearward portion of the piston the vanes are circularly symmetrical and extend completely around the piston.

5. The seal of claim 4 wherein, in a forward portion of the piston the vanes are circularly symmetrical and extend completely around the piston.

6. The seal of claim 5 wherein the vanes on the forward and rearward ends of the piston are secured by an arcuate fastener which extends through the piston member in a central portion of the piston.

7. The seal of claim 1 wherein the vanes are stiff, pivotally mounted to the piston member, have rearward portions which can move toward or away from the piston member when the vanes pivot about and, on a radially inward side of the piston member, the vanes have centers of mass located forward from centers of pivoting of the vanes; wherein, when the piston member is circulating in the passage, centrifugal forces acting on the vanes bring the rearward portions of the radially inward vanes against a radially inward wall of the passage.

8. The seal of claim 7 wherein the vanes are mounted on arms extending from the piston member.

9. The seal of claim 8 wherein the arms are curved rearwardly.

10. The seal of claim 7 comprising stops located to limit outward motion of the rearward ends of the vanes.

11. The seal of claim 10 wherein the stops block movement of forward ends of the vanes toward the piston member.

12. A rotary motor comprising a piston mounted to circulate in an annular passage and a seal, the piston comprising an arcuately elongated piston member, the seal comprising a plurality of vanes projecting outwardly and rearwardly form the piston member at locations spaced apart along the piston member, the vanes brushing against walls of the passage.

13. The rotary motor of claim 12 wherein the vanes are stiff, pivotally mounted to the piston member, have rearward portions which can move toward or away from the piston member when the vanes pivot about and, on a radially inward side of the piston member, the vanes have centers of mass located forward from centers of pivoting of the vanes;
wherein, when the piston member is circulating in the passage, centrifugal forces acting on the vanes bring the rearward portions of the radially inward vanes against a radially inward wall of the passage.

14. The rotary motor of claim 13 wherein the vanes are mounted on arms extending from the piston member.

15. The rotary motor of claim 14 wherein the arms are curved rearwardly.

16. The seal of claim 13 comprising stops located to limit outward motion of the rearward ends of the vanes.

17. A seal for a piston circulating in an annular channel, the seal being shaped in the form of a frusto conical surface having a smaller end having a diameter approximately equal to an external diameter of the piston and a larger end having a diameter approximately equal to an internal diameter of the channel.

18. A piston adapted to circulate in an annular channel, the piston comprising an array of seals as claimed in claim 17 and a piston member, each of the array of seals having its smaller end affixed to the piston member.

19. A method for sealing a piston in a rotary device having a piston which circulates about a center of rotation in an annular passage, the method comprising providing a vane pivotally mounted to the piston, the vane pivotal about a pivot axis and having a center of mass located forward from the pivot axis, allowing a rearward end of the vane to bear against a wall of the passage radially inwardly from the piston, and, as the piston circulates in the passage, allowing centrifugal forces acting on the center of mass of the vane to bias the center of mass radially outwardly, thereby biassing the rearward end of the vane against the wall of the passage.
